(19) United States
(12) Patent Application Publication
(10) Pub. No.: US 2006/0107774 A1
(43) Pub. Date: May 25, 2006

(54) Probe for permeation carrier gas method, measuring apparatus and measuring method

(75) Inventor: Michael Meyberg, Russikon (CH)

Correspondence Address: RENNER OTTO BOISSELLE & SKLAR, LLP, 1621 EUCLID AVENUE, NINETEENTH FLOOR, CLEVELAND, OH, 44115, US

(73) Assignees: Dr. Michael Meyberg; Dr. Roland Kunzli

(21) Appl. No.: 10/997,686

(22) Filed: Nov. 24, 2004

(51) Int. Cl. G01D 21/00

(52) U.S. Cl. 73/866.5

(57) ABSTRACT

The invention relates to a probe for measuring the partial pressure of a gas in a fluid according to the permeation carrier gas method, in particular of oxygen or hydrogen, in a fluid at high temperatures and/or high pressures. The probe comprises a probe body having a wall which comprises a dense plastic layer which is permeable to the gas to be measured, wherein the outside of said plastic layer is in contact with the fluid. The wall of the probe additionally comprises a porous carrier material which is arranged on the inside of the dense, permeable plastic layer and is connected at least at portions to said plastic layer in order to support the plastic layer. Furthermore, the present invention relates to measuring apparatus comprising such a probe, as well as to a measuring method with such a probe.

### FIELD OF THE INVENTION

The present invention relates to a probe for measuring the partial pressure of a gas in a fluid according to the permeation carrier gas method. A particularly preferred application relates to measuring the partial pressure of a gas, for example oxygen or hydrogen, in liquid media or in gaseous or supercritical media, particularly preferred at high temperatures and/or high pressures. Furthermore, the present invention relates to a method for producing such a probe, measuring apparatus and a measuring method with such a probe, as well as to a computer program for implementing a measuring method according to the invention.

### RELATED STATE OF THE ART

In the state of the art, the partial pressure of a gas in a fluid is often measured with a Clark-type sensor which comprises a diffusion barrier which separates the fluid from an electrolyte reservoir of the sensor. Gas which passes through the diffusion barrier causes a chemical reaction on the electrolyte side of the sensor, which reaction is measured, wherein the results allow conclusions on the precise concentration or partial pressure of the gas on the fluid side of the sensor. As is well known, Clark-type sensors are not suitable for carrying out measurements at high temperatures and pressures. Due to the normally exponentially increasing permeation rate of dissolved components on the fluid side, the electrolyte composition on the electrolyte side changes too quickly, or the electrolyte is used up in a very short time, so that the sensor can no longer be used. Furthermore, the materials normally used in the diffusion barrier of Clarke-type sensors are not suitable for carrying out measurement at high temperatures and/or pressures, as they are intended according to the present invention, namely in particular for carrying out measurements in the temperature range from approximately 60 to approximately 160° C. or beyond, and/or in the pressure range from approximately 2 to approximately 100 bar.

U.S. Pat. No. 6,192,737 B1 discloses a measuring apparatus for measuring the CO₂ concentration in drinks. The drink moves along a membrane unit on whose permeate side a purge gas of a specific concentration flows at a specific flow rate. At the gas outlet of the permeate side there is a gas sensor for determining the gas concentration in the purge gas. From the known permeability of the membrane unit, the mass flow, the temperature and a known calibration curve, it is possible, based on the measured gas concentration in the purge-gas flow, to infer the gas concentration in the drink flow.

This sensor is not suitable for locally resolved in-situ measurement, for example in a chemical reactor, because fluid from the reactor has to be diverted to the sensor unit. Along the entire way to the sensor device, the temperature conditions and/or pressure conditions of the reactor have to be maintained, which would be expensive to implement. The sensor device is also not suited for use at high temperatures and/or pressures because the membrane would disintegrate, or at least deform, and its permeability would change significantly.

U.S. Pat. No. 6,277,329 B1 discloses a device for measuring the partial pressure of dissolved hydrogen according to the permeation carrier gas method. This measuring method, too, uses a membrane unit which is to be arranged externally, i.e. outside the measuring location. The membrane unit is a composite hollow fibre membrane unit as is known for example from JP 11-114387 A. A plurality of membrane tubes are cemented in a casting compound near the face ends and are interconnected on the permeate side. Thus a large surface is available for gas permeation. Fluid with the dissolved gas to be measured is conducted past the membrane tubes. On the permeate side, by means of negative pressure, dissolved gas from the fluid, which passes through the walls of the membrane tubes, is siphoned off and then detected.

Because the measuring apparatus has to be attached externally, it is not suitable to locally-resolved in-situ measurements. The design of the sensor is in particular also not suitable for performing measurements at high temperatures and/or pressures. Measurements, in particular on mains water, in a temperature range to approximately 100° C. max. are disclosed.

U.S. Pat. No. 6,679,096 B1 (corresponding to DE 199 25 842 A1) discloses a method for measuring the concentration of gases in fluids, in which in a tubular vessel with a gas-permeable PTFE wall the partial pressure change, which is proportional to the gas concentration, is measured on the permeate side. The thermoplastic PTFE wall is not suited for measurements at high temperatures and/or pressures, because it deforms. The measuring vessel disclosed is thus not suitable for the permeation carrier gas method.

### SUMMARY OF THE INVENTION

It is the object of the present invention to provide a probe for carrying out in-situ measurements in chemical reactors or closed vessels, with which probe the partial pressure of a gas in a fluid according to the permeation carrier gas method can be detected still more easily and reliably, in particular for measurements at high temperatures and/or high pressures. According to a further aspect of the present invention, a probe is to be provided which can be produced still more easily and reliably. Furthermore, a method for producing such a probe, measuring apparatus and a measuring method as well as a computer program for such a measuring method is to be created.

According to the invention, a probe for the above-mentioned purposes is created, comprising a probe body with a wall, wherein the wall comprises a dense plastic layer which is permeable to the gas to be measured, wherein the outside of said plastic layer can be brought into contact with the fluid and the gas which is dissolved or contained in said fluid, wherein the wall additionally comprises a porous carrier material which is disposed on the inside of the dense, permeable plastic layer and is connected at least at portions to said plastic layer in order to support the plastic layer, wherein the carrier material can be brought into contact with a carrier gas which flows through the probe.

In a surprisingly simple manner, the present invention creates a probe which not only provides the advantageous permeation characteristics of dense, permeable (to the gas to be measured) plastic layers which usually soften at high temperatures and/or pressures, but also, due to the connection of the dense permeable plastic layer with a suitable carrier material, provides adequate mechanical support of the plastic layer, so that the probe can without further ado be used also at high temperatures and/or pressures. According to the invention, to this effect the carrier material is porous and thus adequately gas-permeable so that the permeation rate, into the carrier gas, of the gas to be measured, if impeded at all, is impeded only insignificantly in the context of the intended measuring purposes as a result of the dense permeable plastic layer in the carrier gas. Advantageously, the material of a probe according to the invention is a composite material which can be shaped in a simple way in order to make possible in-situ measurements, for example in chemical reactors or closed vessels, even at high temperatures and/or pressures.

According to the invention, the material of the probe is formed so as to constitute an essentially closed shape so that the probe can be immersed in a simple way into the fluid to be measured. In the context of the present application, the term “closed shape” in particular means that essentially the entire outside surface of the probe in the immersion region in the fluid, i.e. the entire permeation zone, comprises the dense permeable plastic layer so that according to the invention a relatively large permeation surface is available for gas penetration. Preferably, essentially the entire inside of the probe comprises the porous carrier material past which the permeation gas can move unhindered. According to the invention the porosity of the carrier material is selected so as to make possible an essentially unhindered mass transfer between the carrier gas and the gas permeated through the plastic, while providing adequate mechanical stability, so that excellent measuring sensitivity can be achieved in a simple way.

In the above-mentioned closed shape, a probe according to the invention can be made so as to be comparatively small so that locally or spatially resolved measuring is easily possible. In particular locally-resolved gradient measuring for determining gas concentration gradients in chemical reactors or closed containers is possible, in particular at high temperatures and/or pressures. To this effect, the probe can also be held so as to be movable and positionable in the vessel containing the fluid.

According to a further embodiment the carrier material is a channel-free porous carrier material of through-connected porosity for the essentially unhindered passing of permeated gas to an interior flow space within the probe, through which interior flow space the carrier gas flows in the permeation carrier gas method. For the purpose of the present invention, the term “through connected” refers in particular to a design where transversely to the porous carrier material an essentially through-connected gas column for the permeated gas exists locally, wherein said gas column however is not straight (channel-like) in shape, but instead is meandering, or random transversely to the carrier material from the contact area with the dense permeable plastic layer to the interior of the gas flow space of the probe. It is advantageous that by varying the parameter of the porosity of the carrier material in an advantageously simple way it is not only possible to ensure an adequate penetration of the gas to be measured from the dense permeable plastic layer to the interior of the gas flow space but also, at the same time, to provide good mechanical stability of the probe because the voids in the carrier material, which voids are meandering or extending at random transversely to the carrier material, ensure good dimensional stability even at high external pressures. At the same time the porous carrier material also ensures a gas exchange area of optimal size for the permeated gas in the carrier gas flow to pass to the interior gas flow space of the probe.

In a surprising way, the external surface of the porous carrier material provides advantageous connection characteristics. Surprisingly, there is no blister formation or bubbling which can be observed in similar applications in other fields, e.g. in providing corrosion protection to a surface by means of a plastic layer, i.e. partial separation of the plastic layer from a non-porous carrier at high temperatures. Morphological investigations have shown that in the production process (described below) the melted-on or applied plastic partially enters the pores of the porous carrier so that the plastic layer is anchored in the carrier material. This results in significantly better than expected adhesion of the plastic layer to the carrier material. Furthermore, permeating substances are carried away by the carrier gas flow so that it is not possible for closed gas voids to form between the carrier material and the plastic layer. Also in the case of melting-on or applying the plastic layer such removal of gas by the porous carrier is advantageous since this results in an advantageous prevention of blisters forming at the contact surface between the carrier and the plastic layer, so that the plastic layer optimally adheres to the carrier.

According to a further embodiment, the carrier material has a porosity, which provides permeability to gases, ranging from approximately 10 to approximately 80%, preferably from approximately 15 to approximately 80%, and still more preferably ranging from approximately 15 to approximately 60%. Preferably, at least at the contact surface between the plastic layer and the carrier material, the porous carrier material has an average pore size ranging from approximately 1 to approximately 300 microns, more preferably ranging from approximately 2 to approximately 150 microns, and still more preferably ranging from approximately 5 to approximately 100 microns.

According to a further embodiment, the porous carrier material is an inorganic material which provides adequate temperature stability and pressure resistance. Preferably, the inorganic material is a material or a material combination selected from a group comprising: stainless steel, metal, metal alloys, glass and ceramics. The carrier material is designed in a suitable way to provide adequate porosity. To this effect the carrier material can basically also be a comparatively fine-meshed knitted fabric or a mesh-like structure of an essentially closed form. It is particularly preferred if the porous carrier material comprises a sintered powder, in particular a sintered metal or ceramic powder. Basically, sintering can also take place with the use of an organic powder, in particular PTFE powder. By way of sintering, in an advantageously simple way the porosity of the carrier material can be varied across a wide range, and at the same time an essentially closed shape for the probe can be provided.

According to a further embodiment the porous carrier material is preferably integrally connected to the dense permeable plastic layer, in particular by being melted onto the porous surface of the carrier material.

According to a further embodiment, the dense permeable plastic layer preferably comprises a thermoplastically workable plastic of an adequate permeation rate for the gas to be measured, in the intended temperature range and/or pressure range. Particularly preferred, the material of the dense permeable plastic layer is applied to the porous carrier material by powder coating, and by subsequent heating to temperatures above the melting point or softening point of the plastic is applied to the carrier material, and is integrally connected, at least in sections, to the porous carrier material.

Penetration of the molten plastic powder into the pores of the carrier material as a result of capillary action is of great importance to the adhesion of the plastic layer to the porous carrier material. The microscopic meandering indentations on the surface of the porous carrier material are filled with plastic and after cooling form a penetrating compound of carrier material and plastic layer. Consequently, the applied plastic layer is well anchored in the carrier material and cannot separate. The plastic layer produced in this way can be exposed to high pressures and temperatures without deforming.

According to a further embodiment, powder coating of the porous carrier material with the plastic particles takes place by electrostatic spraying onto the porous carrier, in which the plastic powder particles are at first automatically spaced apart with the largest possible mutual space from each other on the surface of the porous carrier material. During the subsequent softening of the plastic particles, the plastic layer, which advantageously has been applied evenly, combines with the porous carrier whose pores carry away any gas bubbles from the contact surface between the carrier and the plastic layer, in this way promoting an intimate connection between the carrier and the plastic layer.

In the measuring apparatus according to the invention, a probe tip plunging into the fluid with the gas to be measured is essentially of a closed design, wherein the dense permeable plastic layer essentially completely encloses the porous carrier material towards the outside. The porous carrier material is connected, preferably integrally connected, to a base body of the probe tip, in particular by welding, soldering or gluing. Pressing the porous carrier material onto the base body may also result in a connection, to the base body, of adequate mechanical strength. In principle, the usual mechanical connections, e.g. screw-type connections, can also be used for connecting the porous carrier material to the base body. Particularly preferably, the probe tip is essentially of cylindrical shape, for example bar-shaped, and can thus be inserted in a simple and space-saving way through an opening in a wall at the measuring location, for example in a wall of a chemical reactor or of a closed container. The comparatively small external dimensions and the essentially cylindrical shape in particular also make it possible to carry out locally or spatially resolved concentration gradient measurements in situ.

According to a further embodiment, on the outside of the probe tip the measuring apparatus comprises a connection section for gas-proof and/or pressure-proof connection of the probe to a wall at the measuring location, for example a chemical reactor or closed vessel which contains the fluid with the gas to be measured. The temperature resistance and/or pressure resistance of the connection section is designed so as to cope with the usually experienced operating conditions; in particular, said temperature resistance and/or pressure resistance can be designed for measurements ranging from approximately 2 to at least approximately 100 bar and temperatures ranging from approximately 60 to at least approximately 160° C. and above.

According to a further embodiment, a humidity sensor and/or gas sensor is disposed within the probe or probe tip, for example in the interior gas flow space through which carrier gas flows, with said humidity sensor and/or gas sensor reacting to leaks in the probe, thus, for example, in the case of gas concentration measuring in liquids, responding on the basis of liquid penetration through the probe, or in the case of gas concentration measurements in gaseous media, responding to gas penetration, through the probe, by a gas other than the carrier gas.

According to a further embodiment, a signal of the humidity sensor and/or gas sensor is transmitted, wirelessly or by wire, to a control means which for example is disposed outside the measuring location, which control means, in the case of the humidity or gas concentration exceeding a specified threshold value, assumes a leakage in the probe and as a reaction thereto, in a gas inlet and/or gas outlet for the carrier gas flowing through the device, automatically activates and blocks valve means, in particular check valves so as to prevent any further leakage of fluid from the measuring location, in particular from the measuring location which is subjected to high pressure and/or high temperature. Preferably the valve means, for example the check valve, is matched to the operating conditions at the measuring location, for example being pressure resistant to approximately 20 bar, more preferably to approximately 100 bar, and still more preferably pressure resistant to approximately 250 bar.

According to a further aspect of the present invention, a method comprising the following steps is provided:
providing a porous carrier material;
providing a dense plastic layer which is permeable to the gas to be measured; and
at least at portions, connecting the dense permeable plastic layer to the porous carrier material in order to support the plastic layer disposed on the outside of the carrier material.

According to a further embodiment, the step of providing a carrier material comprises a sintering step for sintering the carrier material from a powder, preferably an inorganic powder, in particular a metallic or ceramic powder.

According to a further embodiment, the step of providing the dense permeable plastic layer comprises powder coating, in particular according to an electrostatic spray process, and melting of a powder layer onto the porous carrier material by heating the powder layer above the melting point of the powder layer, so as to form the dense permeable plastic layer, wherein the thickness of the plastic layer is approximately in the range of approximately 20 to 1000 micron, more preferably in the range of approximately 20 to 500 micron, and still more preferably in the range of approximately 30 to 400 micron.

According to a further embodiment, a bonding agent is placed between the dense permeable plastic layer and the porous carrier material.

According to a further embodiment, resin components or additives are admixed to a plastic powder.

According to the invention a computer program is thus also provided which instructs a processor means, in particular a computer or microprocessor, for the purpose of monitoring the output signal of the humidity sensor and/or gas sensor, and if a settable threshold value is exceeded, of activating a valve means, in particular a check valve. The computer program can in particular also calculate calibration data and measuring data, wherein the current measured values are displayed to the user by corresponding auxiliary devices. The computer program can be stored on a computer-readable data carrier, for example on a diskette or on some other magnetic or optical data carrier, or it can be downloadable over a network, including over the internet.

### BRIEF DESCRIPTION OF DRAWINGS

Hereinafter, the invention is described in an exemplary manner with reference to the enclosed drawings, wherein

FIG. 1 shows a schematic cross section of a probe according to the present invention, which in situ using a closed container measures the partial pressure of a gas in a fluid according to the permeation carrier gas measuring method;

FIG. 2 schematically shows a measuring method according to the present invention;

FIG. 3 shows an enlarged partial section of a further embodiment of a probe according to the present invention, with a protective device; and

FIG. 4 shows a schematic cross section of a probe according to the present invention, according to a further embodiment.

In the figures, identical reference numerals designate identical components or functional units, or components or functional units which essentially have the same effect.

### DETAILED DESCRIPTION OF PREFERRED EMBODIMENTS

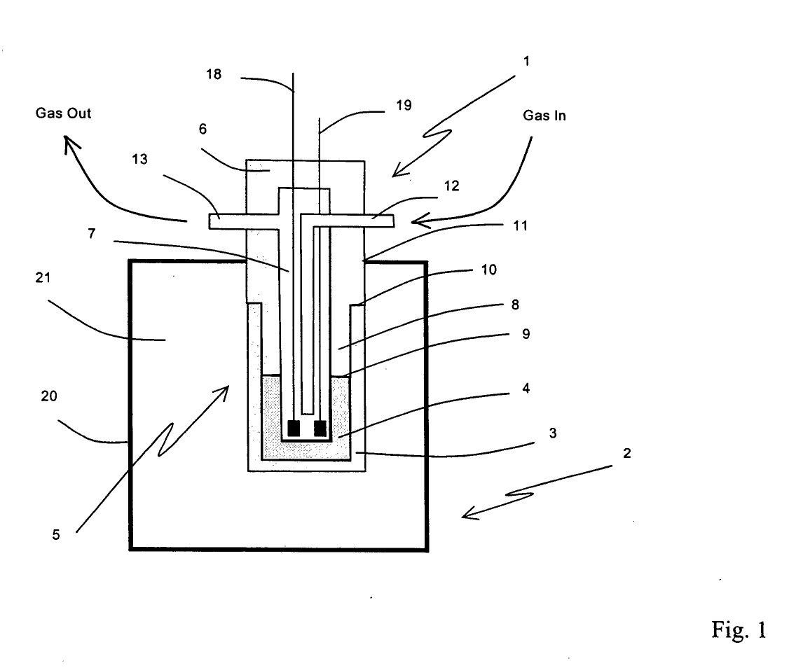

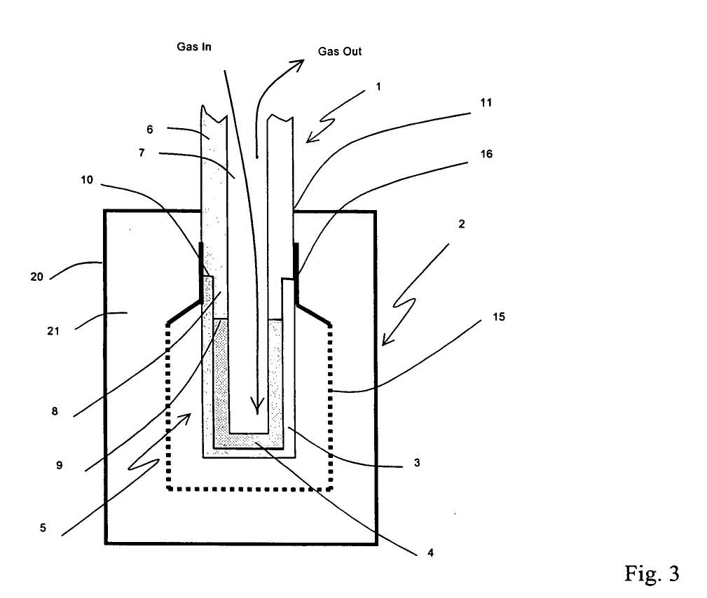

FIG. 1 shows a schematic cross section of a probe 1 according to the present invention which protrudes through a wall 20 of a schematically shown chemical reactor or closed container 2 and measures the partial pressure of a gas in the fluid 21. The probe 1 is designed for the permeation carrier gas measuring method and comprises an essentially cylindrical base body 6 with a carrier gas inlet 12 and a carrier gas outlet 13 and an essentially cylindrical interior flow space 7 through which the carrier gas flows from the inlet 12 to the outlet 13. At the front end of the probe 1 at the probe tip there is provided the permeation zone 5. In this zone a porous carrier 4 is provided which is enclosed by a dense permeable plastic layer 3. The porous carrier 4 is in contact with the carrier gas flow and forms the front end of the interior flow space 7, preferably completely, so that there is a large contact surface with the carrier gas flow. At the probe tip, the protective device which is shown as an example in FIG. 3 can be disposed.

The front end 8 of the base body 6 can also be formed in a stepped manner, as shown in the figure, so that the dense plastic layer 3 closes off essentially flush with the outside of the cylindrical base body 6. As shown, the dense plastic layer 3 can project beyond the rear end of the porous carrier 4 towards the carrier gas inlet/outlet 12, 13, and at the projection can be connected to the base body 6, in particular in the manner of an adhesive bond, for example by melting on or gluing on.

The porous carrier material 4 is connected to the front end 8 of the cylindrical base body 6 via the connection section 9. On the outer section of the cylindrical base body 6 there is a connection section 11, for example a screw-type thread with a sealing section or a circumferentially extending flange with seal so that the probe can be inserted in a pressure resistant and/or temperature resistant way against the wall 20 of the closed container 2. The probe 1 makes it possible to carry out in-situ measuring of the gas concentration or the partial pressure in the fluid 21. In order to be able to measure concentration gradients in the container 2 also in a locally resolved manner, the connection section 11 can also be designed such that the measuring probe 1 is movable in the container 2 so that the probe tip with the permeation zone 5 can be positioned at various locations in the fluid.

The fluid 21 can be liquid, gaseous or supercritical. The gas to be measured, which gas is contained in the fluid 21, can in particular be oxygen or hydrogen. Typical operating conditions of the container 2 are a temperature ranging from approximately 60 to at least approximately 160° C. and an interior pressure of the container 2 ranging from approximately 2 to at least approximately 100 bar, wherein the fluid can be neutral, alkaline or acidic or wherein it can be a solvent. The present invention is however not limited to the above-mentioned areas of application.

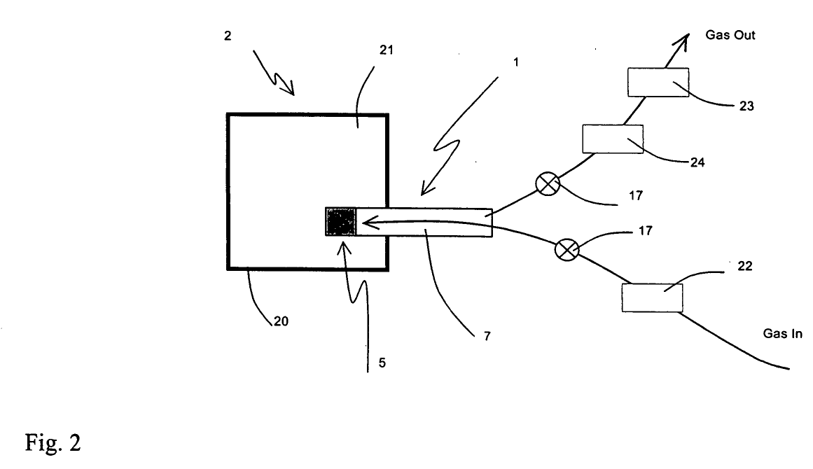

The dense permeable plastic layer has a suitable permeation rate for the gas to be measured at the intended operating conditions. At least at portions, the dense permeable plastic layer 3 is connected to the porous carrier material 4. The through-connected porosity of the carrier material is adequate to impede the gas penetration of the permeated gas into the carrier gas flow either not at all or only insignificantly. The porous carrier material 4 is used for mechanically supporting the plastic layer 3 and at the same time ensures adequate gas exchange of the permeated gas with the carrier gas flow. At least in the region of the permeation zone 5 (compare FIG. 2), the probe 1 is axially symmetrical or symmetrical with respect to the centre of the image so that the pressures experienced in the container 2 can be sensed by the probe 1 in a way which involves particularly low tension.

In the interior flow space 7, preferably at the front end, sensors can be provided, for example a humidity sensor 18, a temperature sensor 19 or a gas sensor (not shown). The sensor signals are transmitted by wire or wirelessly, to a control system or regulating system arranged away from the measuring location. The temperature sensor measures the temperature on site (in situ). A further temperature sensor is disposed at a suitable position in the container 2, but it can also be disposed outside the probe 1. The humidity sensor 18 measures humidity or liquid which in the case of a leakage in the probe 1 enters the interior flow space 7. The gas sensor (not shown) responds to a gas other than the carrier gas, which in the case of a leakage in the probe passes from the interior 21 of the container 2 into the interior flow space 7.

FIG. 2 schematically shows a permeation carrier gas measuring method according to the present invention. The mass flow of a carrier gas, for example nitrogen, is adjusted by means of a mass flow regulator 22. The carrier gas flows through the interior 7 of the probe 1 and enriches itself on the probe tip with the gas passing through the dense permeable plastic layer 3 and through the porous carrier material 4 in the region of the permeation zone 5. The carrier gas enriched in this way moves from the outlet 13 to a sensor or measuring instrument 23 where its composition is examined in a known way. For example, if oxygen or hydrogen is measured, the sensor 23 can be a known electrochemical sensor. A gas scrubber 24 can be disposed upstream of the sensor 23, with said gas scrubber 24 preventing materials which would impede or even destroy the sensor 23 from being conveyed. A check valve 17 is provided both in the gas inlet and in the gas outlet. At least up to the check valves, the flow connections are adequately temperature resistant and/or pressure resistant in accordance with the operating conditions in the container 2.

If the permeation, through the plastic layer 3, of the gas to be examined is known as a function of the temperature and of specific medium influences, which may require calibration, then this measuring method can be used to determine the partial pressure of the gas in the fluid 21 in a way which is known per se. Typical mass flows range from approximately 0.01 to 0.1 l/min at standard conditions (atmospheric pressure, room temperature). By switching valves (not shown) optionally the carrier gas or a calibration gas can be conveyed through the probe 1 to the sensor 23. While taking performing measurements, the probe 1 can be continuously rinsed so as to be ready for action immediately. Typical response times can be in the range from <10 minutes (90% response accuracy). In addition to the signal of the sensor 23, the temperature of the fluid 21 is available as an external measuring signal. Software is used to calculate the actual partial pressure of the gas in the fluid 21 from the measured signals and calibration data which has been obtained in the way stated below.

If the humidity sensors and/or gas sensors 18 disposed in the probe respond, or if on the basis of other measured signals a potential leakage of the probe 1 can be assumed, then, triggered by software according to the invention, the electronics automatically activate the check valves 17 in order to prevent uncontrolled leakage of the fluid 21 from the container 2.

Calibration of the measuring apparatus takes place as follows: In the case of a set mass flow and known partial pressure of the gas in the fluid 21, which gas has to be measured, the sensor signal is measured as a function of the temperature. Care is taken that the gases and the medium are in thermodynamic equilibrium. Since the rate of permeation through the plastic layer 3 depends not only on the temperature but also on the medium used (e.g. partial pressure of water as a fluid 21), calibration should always be carried out in the same medium in which subsequent measuring is to take place. Each probe should thus be measured at least once under these conditions, without the gas in the fluid being used up by chemical reactions. Subsequently, the probe 1 should be stored in these or similar fluids and should only be used for measuring in such fluids.

By reversing the gas flow with a zero gas, i.e. a gas of a known composition, the zero point of the measuring apparatus can be set, while by reversing the gas flow with a calibration gas of known concentration and composition, calibration of the measuring apparatus can be changed. To this effect, the software or electronics can suitably adjust additional control valves (not shown).

If the fluid comprises a liquid phase and a gaseous phase, the probe tip can also be moved into a gas space, for example into a gas space which contains the gaseous phase above the liquid phase, in which gas space the partial pressure of the gas in many cases is known or measurable in a simple manner. This measurement obtained in the gas space at a known pressure and preferably at a known gas composition can be used to calibrate the probe and can be carried out during the measuring process.

According to a further embodiment, the probe can be calibrated by rinsing, with a gas, the container which holds the fluid, with said gas displacing the fluid in the vicinity of the probe.

The volume flow of gas which passes through the dense permeable plastic layer 3 is given by:
F=P(T)*A*(p1−p2)/L
where: P(T)=permeation constant
A=area of the plastic layer
L=thickness of the plastic layer
p1, p2=partial pressures of the permeate on the two sides of the plastic layer
F=volume flow of the permeating gas.

The temperature dependence of the permeation constant of gases through a dense permeable plastic layer is given by:
P=Po*exp(−Ep/RT)
where: P=permeation constant
Po=constant
Ep=activation energy for permeation of a gas molecule
R=universal gas constant
T=temperature in Kelvin.

This type of dependence is known as the Arrhenius law. A temperature sensor 19 integrated in the probe 1 is not absolutely necessary because the relatively thin plastic layer will anyway very quickly assume the temperature of the medium. Therefore, as a rule, the temperature of the medium is measured using a separate temperature sensor which projects into the fluid 21. The signal of the temperature sensor is available for evaluation.

In addition, the permeation rate of a gas at a given temperature depends on the humidity (e.g. water vapour pressure). Water, as an example of the fluid 21, is a polar molecule which also dissolves in the plastic layer, as a result of which it has an influence on the diffusion, through the plastic layer, of the gas to be examined, e.g. of oxygen.

As far as the influence which humidity has on permeation is concerned, for many materials there is no physical law available. Depending on a given plastic material, the permeation rate can increase or decrease as a result of humidity. There seems to be some dependence between the morphology (crystalline/amorphous) and the type of cross-linkage of the polymers of the dense permeable plastic layer. It is thus only possible to use an experience value for correction.

FIG. 3 shows a further embodiment of the probe 1 according to the invention, in which a protective device 15 is provided in the region of the permeation zone 5. The protective device 15 can serve various purposes, for example it can provide mechanical protection to the dense permeable plastic layer 3 against abrasion by solids particles tossed around in the fluid 21 (wherein the particle size can for example range from 20 to 600 micron, in particular with the use of precious-metal catalysts on an aluminium oxide carrier) or it can be used as a bubble deflector.

The protective device 15 preferably comprises a metal sleeve or a metal mesh which is axially pushed over the probe tip and can be attached to the probe body. The attachment zone 16 of the protective device 15 can be such that the transition 10 between the probe body 6 and the plastic layer 3 is protected against ingressing fluid or is sealed off. For this purpose a bushing-like or sleeve-like extension of the protective device 15 can tightly enclose the transition region 10. Attachment can be supported by a clamping ring (not shown) or by a comparable attachment device.

Furthermore, the protective device 15 is designed such that the fluid 21 can directly flow around the plastic layer 3 at a speed of, for example, more than 10 cm/second. This ensures that the measurements do not depend, or depend only insignificantly, on the flow speed of the fluid 21.

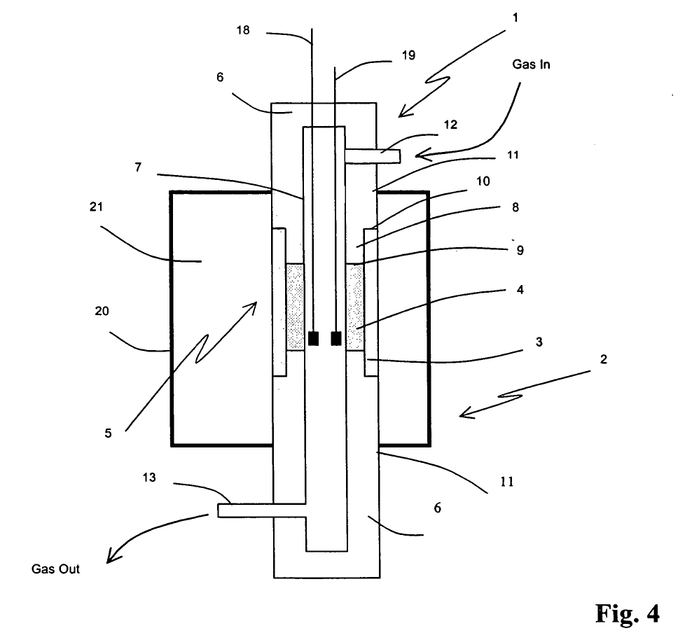

FIG. 4 shows a probe according to a further embodiment of the present invention. In a way different from that shown in FIG. 1, the tubular probe 1 extends through the container 2, i.e. at a first end of the container 2 it enters said container 2 and at the opposite second end of the container it leaves said container 2. At the entry and exit areas, suitable seals (not shown) are provided so that at any intended pressure the fluid does not exit from the container 2. At its upper and lower ends the probe 1 is closed off. According to FIG. 4, the tubular permeation zone 5, which overall is designated by the reference numeral 5, extends in sections in the container 2. According to a further embodiment, the permeation zone 5 can also extend across the entire diameter of the container 2. According to FIG. 4, in the way described above, the permeation zone 5 comprises a porous carrier 4 to support the plastic layer 3 in the way described above. According to FIG. 4, the gas inlet 12 for letting the carrier gas into the interior of the probe 1 is located at the upper end of the probe 1, while the gas outlet 13 for letting the carrier gas out of the interior of the probe 1 is located at the opposite lower end of the probe 1.

After the above description of the general operation of the probe 1, below, preferred materials and production processes for the probe 1 according to the present invention are stated in a non-restricting way.

### Embodiment 1 of the Porous Carrier Material

Powder particles from metal or stainless steel, in particular brass, bronze, aluminium, copper or from metal alloys with components of iron, chromium, nickel, titanium, molybdenum, tungsten, yttrium, cobalt, aluminium, copper, manganese and/or vanadium, with an average particle diameter ranging approximately from 1 to 1000 micron, more preferably from approximately 2 to approximately 500 micron, and still more preferably from approximately 5 to approximately 400 micron were placed in a cylindrical mould which comprises a cylindrical mandrel for shaping the essentially cylindrical interior flow space 7. The powder was pressed in the mould. Then the pressed powder was heated in the mould to a high temperature, for example approximately 800° C. until it sintered to form a porous essentially cylindrical carrier. The carrier material is characterised by a medium pore size at the contact surface between the plastic layer 3 and the carrier material 4 ranging from approximately 1 to approximately 500 micron, more preferably from approximately 1 to approximately 200 micron, and still more preferably from approximately 1 to approximately 100 micron. The porosity for permeation at the contact surface as well as in the interior space of the carrier material ranges from approximately 10 to approximately 80%, more preferably from approximately 15 to approximately 80%, and still more preferably from approximately 15 to approximately 60%. This provides adequate mechanical stability during pressure load and a well adhering base due to surface roughness of the carrier material. Due to the permeable porosity, permeation as a result of the subsequently applied dense permeable plastic layer and the removal of the permeated carrier gas through the carrier material to the carrier gas flow is essentially not impeded.

The thickness of the carrier material can be in the range of approximately 1 to approximately 20 mm, more preferably in the range of approximately 1 to approximately 10 mm, and still more preferably in the range of approximately 1 to approximately 6 mm. At any rate, adequate mechanical stability is ensured at temperatures from 20 to 160° C.

### Embodiment 2 of the Porous Carrier Material

A commercial filter element comprising precious metals or other metals, glass or ceramic materials is used, like for example the one commercially available from GKN Sinter Metals Filters GmbH with the designation SIKA-R or by Robu Glasfilter GmbH with the designation Vitrapor. The average pore size is approximately in the range of 1 to approximately 300 micron, more preferably in the range of approximately 2 to approximately 150 micron, and still more preferably in the range of approximately 5 to 100 micron. The material has a porosity in the range of approximately 10 to approximately 80%, more preferably in the range of approximately 15 to approximately 80%, and still more preferably in the range of approximately 15 to approximately 60%.

### Embodiment 3 of the Porous Carrier Material

A plastic material is made porous by melt spinning and pore formation using the extending method. The plastic material is selected with a view to a suitable melting point which matches the operating conditions for measuring. In a non-restrictive way, the plastic material is selected from a group comprising: crystalline polymers, for example fluorinated polymers, olefin system polymers, polyethylene, polypropylene, poly-3-methylbutene-1, poly-4-methylpentene-1, polyvinyl fluoride and polyfluoroethylene. For added rigidity, the porous carrier material can also be arranged on a grid. Typically the pore size of the porous carrier material is smaller than in the above embodiments, for example an average pore size ranging from approximately 1 to 50 micron, more preferably ranging from approximately 1.5 to 45 micron, and still more preferably ranging from approximately 2 to 40 micron. The average porosity is typically somewhat below that of the embodiments described above; it ranges for example from approximately 10 to 50%, more preferably from approximately 15 to 45%, and still more preferably from approximately 20 to 40%.

Experiments have shown that, at higher temperatures of for example above 100° C., this embodiment no longer provides adequate dimensional stability so that preferred operation is in the low-temperature range, for example in the range from approximately 20° C. to approximately 100° C.

### Embodiment 4 of the Porous Carrier Material

A carrier made from a non-expanded sintered porous polytetrafluoroethylene (PTFE) is produced by means of a sintering process in which solid PTFE particles are heated to a high temperature so as to form a porous matrix. Such a material is available by the trade name of ZITEX (Norton Camplast, N.J., USA) and comprises fibrous PTFE, wherein PTFE fibres are glued to form a porous matrix. Such materials can be produced by mixing cellulose-containing or protein-acidic materials with PTFE and by heating them to high temperatures in an oxygen atmosphere in order to burn out or carbonise the cellulose-containing or protein-acidic material and to sinter the PTFE. Such a method is for example disclosed in U.S. Pat. No. 3,775,170, the whole content of which is herewith expressly incorporated in this application.

In a modified embodiment a sintered porous PTFE carrier is made from PTFE particles, comprising granular PTFE particles melted into each other in order to form a porous integral network of interconnected particles. The PTFE particles which are used for creating the porous network are essentially particles made in full or in part from granular PTFE particles, although they can also comprise other types of PTFE particles. The term “sintering” in the context of PTFE in particular refers to heating above the melting point, which for pure, non-modified, PTFE is approximately 343° C. The granular PTFE can comprise homopolymeric tetrafluoroethylene and modified PTFE. Granular Teflon is for example available from DuPont Speciality Polymers Division, Wilmington, USA.

The porous PTFE carrier is characterised by good tensile strength and mechanical strength, wherein the average pore size is smaller than in the previous embodiments, approximately in the range of 1 to 10 micron if abrasive particles of an average grain size of 40 micron were melted to form the above-mentioned network. According to one modification, the granular PTFE particles which are used to produce the sintered porous carrier are made of a mixture of one or several of the following materials:
1. non-sintered finely powdered PTFE;
2. particles made of a thermoplastic fluorinated organic polymer;
3. particles of a low-molecular PTFE micropowder which is made by exposure to radiation.

Organic or inorganic fillers can be admixed to the PTFE particles, in particular also in order to increase the average pore size. Examples of such fillers include carbon, activated carbon, glass, chromium oxide, titanium oxide, silicon dioxide and the like. The fraction of filler can be up to 60 weight-% so that the above-mentioned porosities are achievable in this embodiment too.

Preferably the carrier material according to this embodiment is used in combination with a plastic layer whose material has a lower softening point than the carrier material. A stable connection between the carrier and the plastic layer can be ensured by softening the material of the plastic layer, wherein the carrier material maintains its consistency and shape.

Experiments have shown that—depending on the selection of starting materials—this embodiment also does not provide adequate dimensional stability at elevated temperatures, for example above approximately 100° C., so that the preferred scope of application of embodiment 4 is in the low-temperature range, for example in the range of approximately 10° C. to approximately 100° C.

### Embodiment 5 of the Porous Carrier Material

By combining a suitable plastic material as listed by way of an example in the context of embodiments 3 and 4, with the inclusion of suitable inorganic particles to form a dimensionally stable but porous structure, it has been possible to create a porous composite carrier material. Examples of inorganic particles which can be admixed to the plastic include: carbon or soot particles, aluminium oxide and silicate. By suitable selection of the admixed inorganic particles the porosity of the carrier material can be specified in a simple way. By suitable selection of the mixing ratios of plastic and inorganic fractions, the mechanical cohesion as well as the dimensional stability and temperature stability of the composite material can be specified in a simple way. Preferably, the inorganic particles are also electrically conductive, at least on their surface, so that the plastic layer can be applied by means of the electrostatic spray discharge method described below.

In this way a porous carrier material can be implemented which to a considerable extent is based on organic parent materials but which nonetheless provides adequate dimensional and temperature stability to be used also at elevated temperatures, in particular in the temperature range of approximately 100° C. to approximately 160° C.

Characterisation of the Dense Permeable Plastic Layer

Powder coating, in particular according to the so-called electrostatic spray discharge method, of the above-mentioned metallic porous carrier material is particularly suited to the production of a dense permeable plastic layer. Subsequently, the applied powder coating is heated above the melting point and is melted onto the porous carrier material. The thickness of the dense permeable plastic layer is approximately in the range of 20 to 1000 micron, more preferably in the range of approximately 20 to approximately 500 micron, and still more preferably in the range of approximately 30 to approximately 400 micron.

Self-edging primers can be applied prior to powder coating. Powder coating and melting-on can be repeated several times until the desired layer thickness is achieved. Furthermore, resin components and other additives can be admixed to the plastics.

The plastics used can be commercially available thermoplastics. Preferred parent materials include for example: polytetrafluoroethylene (PTFE), tetrafluoroethylene/hexafluoropropylene copolymers (FEP), tetrafluoroethylene/ethylene copolymers (E/TFE), tetrafluoroethylene/hexafluoropropylene/vinylidene fluoride terpolymer (THV), polytrifluorochloroethylene (PCTFE), polyvinylidene fluoride (PVDF), perfluoroalkoxy copolymer (PFA), tetrafluoroethylene/perfluoromethylvinylether copolymer (MFA), copolymers made of tetrafluoroethylene and fluorided cyclical ether, thermoplastic fluoroelastomers, thermoplastic polycondensates, e.g. aromatic polyether ketones (PEEK), or polyamides (PA).

The melting point of the dense permeable plastic layer is above 200° C. The plastic layer is characterised by water absorption of <0.1 weight-% in water at 23° C. (ASTM D570). The average porosity of the dense permeable plastic layer is <0.1% so that the plastic layer is gas-proof and essentially free of pores (electrical test). Resistance to chemicals according to the test method ASTM D543 is very good. The plastic layer is thus suited to a permanent operating temperature above 140° C., without mechanical load.

Permeation for gases, in particular hydrogen and oxygen, is thus high. At the same time the plastic layer is impermeable to larger molecules, atoms or ions which are dissolved in the fluid. In principle, water can cause the plastic layer to swell if water molecules dissolve therein. This could cause shearing forces along the adhesive surfaces and separation of the plastic layer from the porous carrier material. According to the invention, water absorption of the plastic layer is only small.

As will be easily recognised by an average person skilled in the art who is studying the present description, the fluid can of course also flow through or flood the container continuously or cyclically.

### LISST OF REFERENCE NUMERALS

1 Probe
2 Container
3 Plastic layer
4 Porous carrier
5 Permeation zone/probe tip
6 Base body
7 Interior
8 Front end of the base body
9 Connecting portion probe body/carrier material
10 Transition plastic layer/probe body
11 Connecting portion probe body/container
12 Carrier gas inlet
13 Carrier gas outlet
14 Connecting portion probe/protective device
15 Protective device
16 Check valve
17 Attachment zone of protective body
18 Humidity sensor
20 Wall of the container
21 Fluid in the interior of the container
22 Mass flow regulator
23 Sensor/measuring instrument
24 Gas scrubber/adsorber

What is claimed is:

1. A probe for measuring the partial pressure of a gas in a fluid at high temperatures and/or pressures according to the permeation carrier gas method, comprising:
a probe body having a wall, said wall comprising a dense plastic layer which is permeable to the gas to be measured, wherein the outside of said plastic layer can be brought into contact with the fluid, in which probe the wall additionally comprises a porous carrier material which is disposed on the inside of the dense, permeable plastic layer and is connected at least at portions to said plastic layer in order to support the plastic layer.

2. The probe according to claim 1, wherein the porous carrier material has a through-connected porosity, wherein the porous carrier material is connected in the manner of an adhesive bond to the dense permeable plastic layer.

3. The probe according to claim 2, wherein the porous carrier material has a porosity, which is permeable to the gas to be measured, in the range of 15% to 60%.

4. The probe according to claim 1, wherein the porous carrier material comprises an inorganic material selected from a group consisting of: stainless steel, metal, glass and ceramics.

5. The probe according to claim 1, wherein the porous carrier material is made of a sintered metal powder or ceramic powder.

6. The probe according to claim 2, wherein the porous carrier material has an average pore size at the interface between the plastic layer and the porous carrier material ranging from 5 micron to 100 micron.

7. The probe according to claim 1, wherein the dense permeable plastic layer is made of a thermoplastically workable plastic which is suitable for powder coating by means of electrostatic spraying onto the porous carrier material.

8. The probe according to claim 7, wherein the dense permeable plastic layer is made of a plastic selected from a group consisting of: polytetrafluoroethylene (PTFE), tetrafluoroethylene/hexafluoropropylene copolymer (FEP), tetrafluoro/ethylene copolymer (E/TFE), tetrafluoroethylene/hexafluoropropylene/vinylidene fluoride terpolymer (THV), polytrifluorochloroethylene (PCTFE), trifluorochloroethylene/ethylenecopolymer (E/TFE), polyvinylfluoride (PVF), polyvinylidene fluoride (PVDF), perfluoroalkoxy copolymer (PFA), tetrafluoroethylene/perfluoromethylvinylether copolymer (MFA), copolymers made of tetrafluoroethylene and fluorided cyclical ethyles, thermoplastic fluoroelastomers and polyamides (PA).

9. The probe according to claim 2, wherein the thickness of the dense permeable plastic layer is in the range of 20 to 500 micron, more preferably in the range of approximately 30 micron to 400 micron.

10. The probe according to claim 1, wherein the melting point of the dense permeable plastic layer is above 200° C.

11. The probe according to claim 2, wherein the dense permeable plastic layer completely encloses the carrier material towards the outside.

12. The probe according to claim 1, wherein the probe body comprises a cylindrical base body with a stepped front end, wherein the outside of the plastic layer closes off essentially flush with the outside of the base body.

13. The probe according to claim 1, further comprising an interior through which a carrier gas can flow, wherein a sensor is disposed in the interior of the probe, which sensor has been selected from a group consisting of: a temperature sensor, a humidity sensor and a gas sensor.

14. The probe according to claim 1, wherein the permeation zone, of which there is at least one, into which permeation zone the gas to be measured passes through the dense permeable plastic layer and the porous carrier material, is cylindrical or spherical in shape.

15. A device for measuring the partial pressure of a gas in a fluid at high temperatures and/or pressures according to the permeation carrier gas method, comprising a probe which comprises a probe body having a wall, wherein:
the wall comprises a dense plastic layer which is permeable to the gas to be measured, wherein the outside of said plastic layer can be brought into contact with the fluid, and the wall of the probe additionally comprises a porous carrier material which is disposed on the inside of the dense, permeable plastic layer and is connected at least at portions to said plastic layer in order to support the plastic layer.

16. The device according to claim 15, further comprising a connecting portion for gas-proof and/or pressure-proof connection of the probe to a wall of a chemical reactor or closed vessel which contains the fluid with the gas to be measured, wherein the connecting portion is designed for a prevailing pressure in the interior of the reactor or container in the range of 2 bar to at least 100 bar, and for a temperature in the interior of the reactor or container of 60° C. to at least approximately 160° C.

17. The device according to claim 16, wherein the probe body can be displaced in a linear way in order to position the probe tip at specifiable locations in the fluid.

18. The device according to claim 17, further comprising a protective body in order to protect the probe against abrasion by abrasive particles present in the fluid, or to serve as a bubble deflector, wherein the protective body is essentially cylindrical and can be clipped and attached axially to the probe body, wherein the protective body comprises a bushing-like extension in order to provide a seal against ingressing fluid in a transition region between the permeable plastic layer and the probe body.

19. The device according to claim 18, comprising a check valve provided in at least one of a gas inlet and a gas outlet for a carrier gas flowing through the device, wherein the check valve provides blocking action to a pressure of up to 100 bar, further comprising a control means in order to receive a signal of one the humidity sensor and the gas sensor disposed within the probe, and in order to block the check valve if one of the humidity and the concentration of a gas—which is a gas other than the carrier gas—that is detected in the probe by means of the gas sensor in the probe exceeds a specifiable threshold value.

20. A method for measuring the partial pressure of a gas in a fluid at high temperatures and/or pressures according to the permeation carrier gas method by means of a probe comprising a probe body having a wall, said the wall comprising a dense plastic layer which is permeable to the gas to be measured, wherein the outside of said plastic layer is in contact with the fluid, in which probe the wall additionally comprises a porous carrier material which is disposed on the inside of the dense, permeable plastic layer and is connected at least at portions to said plastic layer in order to support the plastic layer, in which method:
a control means receives a signal of one of a humidity sensor and a gas sensor disposed within the probe; and
a check valve, which is disposed in one of a gas inlet and a gas outlet for a carrier gas which flows through the probe, blocks if one of the humidity and concentration of a gas—which is a gas other than the carrier gas—that is detected within the probe by means of the gas sensor within the probe exceeds a specifiable threshold value.

21. The method according to claim 20, additionally comprising the step in that by reversing the flow of the carrier gas through a downstream gas sensor and through the probe by means of additional control valves, the zero point of the downstream gas sensor is set during measuring operations.

22. The method according to claim 21, additionally comprising the step in that by reversing the flow of the gas through a downstream gas sensor and through the probe by means of additional control valves, the sensitivity of the downstream gas sensor is set.

23. The method according to claim 22, additionally comprising the step in that by shifting the probe from the fluid the probe is calibrated in a gas space above the fluid.

24. The method according to claim 22, in which by rinsing a container which stores the fluid, the probe is calibrated by means of a gas which displaces the fluid in the vicinity of the probe.
